(19) United States
(12) Patent Application Publication
(10) Pub. No.: US 2008/0023155 A1
(43) Pub. Date: Jan. 31, 2008

(54) ROLLER-BLIND DEVICE AS WELL AS WIND DEFLECTOR AND MOTOR VEHICLE HAVING A ROLLER BLIND DEVICE

(75) Inventors: Dominik BEIERL, Korntal-Muenchingen (DE); Felix HERMANN, Leonberg (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 11/828,031

(22) Filed: Jul. 25, 2007

(30) Foreign Application Priority Data
Jul. 26, 2006 (DE) 10 2006 034 446.4

(51) Int. Cl. E06B 9/42; B60J 1/20

(52) U.S. Cl. 160/121.1; 180/313; 296/97.8

(57) ABSTRACT

A roller-blind device for a motor vehicle has a first flexible flat structure and a second flexible flat structure that are attached to a rotatable roller-blind axis and situated so that they are rollable onto and unrollable from the roller-blind axis in different directions (22, 24; 33, 34). The roller blind device can be incorporated in a wind deflector.

### RELATED APPLICATIONS

This application claims priority from German patent application number DE 10 2006 034 446.4, filed Jul. 26, 2006, the disclosure of which is incorporated by reference herein in its entirety.

### BACKGROUND AND SUMMARY OF THE INVENTION

The present invention relates to a roller-blind device as well as a wind deflector and a motor vehicle having such a roller-blind device.

A wind deflector for a motor vehicle, shown in DE 197 25 217 C1 has a roller-blind device which contains a flexible flat structure. The flexible flat structure is rollable onto a roller-blind axis for a neutral position of the wind deflector and is unrollable therefrom for an active position of the wind deflector. The roller-blind axis is situated fixed in place in the motor vehicle on the rear area. The flat structure is connected at one front edge to the roller-blind axis and at another front edge to a transverse element of a pivotable stretching bow.

In the wind deflector, a deflection support is connected in an articulated way to the stretching bow. The deflection support has a transverse element that is used as the deflector for the rollable and unrollable flat structure. To pivot the wind deflector into its active position, the deflection support is shifted horizontally using a type of scissor joint. This movement is transmitted to the stretching bow. Both the deflection support and also the stretching bow attached thereto thus stand up.

The pivoting of deflection support and stretching bow causes the unrolling of the flat structure. The known wind deflector is pivoted into its neutral position in the reverse path by a horizontal movement of the deflection support in the opposite direction. A drive of the wind deflector using such a scissor joint is complex to implement and requires a large amount of space.

An object of the present invention is to make possible a roller-blind device which may also be implemented in a technically simple way.

This object has been achieved by a roller-blind device, a wind deflector, or a motor vehicle in which the roller-blind device has a first flexible flat structure and a second flexible flat structure, wherein both structures are attached to a rotatable roller-blind axis and situated so that they are rollable onto the roller-blind axis and unrollable from the roller-blind axis in different directions. The two flat structures are particularly rollable onto the roller-blind axis for a neutral position of the roller-blind device and are unrollable from the roller-blind axis for an active position of the roller-blind device. In the active position, the two flat structures span active areas which may be used as protective areas. In the neutral position, the two flat structures do not span any such active areas.

On the basis of the present invention, a roller-blind device may be implemented which has a small number of components and may therefore be produced and mounted cost-effectively. The roller-blind device according to the present invention may be used easily for different intended purposes. Adaptation of the roller-blind device to these intended purposes is now possible especially easily. A single roller-blind axis is advantageously sufficient for both flat structures. Particularly advantageously, the two flat structures may be unrolled from and/or rolled onto the roller-blind axis simultaneously. The active or neutral position may thus be set rapidly.

In one advantageous embodiment of the present invention, the first flat structure and the second flat structure are rolled onto the roller-blind axis lying one on top of another in the neutral position of the roller-blind device. The two flat structures are particularly wound double onto the roller-blind axis. They are located rolled on the roller-blind axis parallel to one another and in a spiral in the neutral position. It is thus possible to situate both flat structures compactly on the roller-blind axis.

Preferably, one front edge of the first flat structure and one front edge of the second flat structure are attached to the roller-blind axis and another front edge of the first flat structure is attached to a first strut and another front edge of the second flat structure is attached to a second strut. Particularly the front edges may be attached especially well and solidly to the roller-blind axis and the two struts. Furthermore, the two flat structures may thus be exploited particularly efficiently. The material outlay for spanning the active areas may be kept low, because no areas of the flat structures overlap beyond the struts.

In a further advantageous embodiment, the first strut and/or the second strut are extendable from the roller-blind axis for unrolling and rolling the first flat structure and/or the second flat structure from or onto the roller-blind axis. This allows the unrolling and rolling of the flat structures especially simply and reliably.

In a currently especially preferred embodiment of the present invention, the first strut or the second strut is mounted to be fixed in place. Furthermore, the roller-blind axis is extendable for unrolling and rolling the first flat structure and/or the second flat structure from or onto the roller-blind axis. Simple and reliable rolling and unrolling may thus also be made possible for a specific application.

The first flat structure and the second flat structure especially advantageously each have a net-like material that is especially flexible and may thus be rolled and unrolled especially well. Furthermore, the material may be tensioned well, so that the active areas spanned thereby offer particularly good protection.

The wind deflector according to the present invention preferably has a stretching bow mounted so it is pivotable around a pivot axis running in the transverse direction of the motor vehicle and is fixed in place, and a roof arch that is mounted so it is pivotable around a pivot axis running in the transverse direction of the motor vehicle and is fixed in place in particular. The pivot axis of the roof arch is at a distance from the pivot axis of the stretching bow in the longitudinal direction of the motor vehicle. Furthermore, the roller-blind axis is implemented on the roof arch parallel to its pivot axis.

Pivoting of the wind deflector between a neutral position, in which it particularly lies essentially at the height of an equator of the motor vehicle and does not ensure any wind protection, and an active position, in which it has an essentially vertical orientation and ensures wind protection, is thus possible especially simply. Due to the separate and fixed mounting of the stretching bow and roof arch, their shapes and dimensions may advantageously be implemented largely independently of one another.

Furthermore, especially good stability and reliability of the configuration is provided. The stretching bow and the roof arch are particularly mounted to execute a rotating movement. The pivot axis of the stretching bow is advantageously situated in front of the pivot axis of the roof arch in the forward travel direction of the motor vehicle.

The roller-blind axis is especially preferably implemented on a transverse web of the roof arch running parallel to the pivot axis of the roof arch. This allows an especially space-saving embodiment of the wind deflector.

Preferably, the first flat structure is attached to the stretching bow and the second flat structure is attached fixed in place to the motor vehicle, in particular in a rear area of the motor vehicle. The first flat structure thus spans an active area, which is used as a wind protector in the active position of the wind deflector between the attachment to the stretching bow and the roller-blind axis implemented on the roof arch. The first flat structure advantageously runs largely vertically in this case. The second flat structure spans a cover area between the roller-blind axis implemented on the roof arch and the fixed attachment to the motor vehicle that may advantageously be used, for example, as a cover for a rear seat area of the motor vehicle or a convertible-top compartment of a cabriolet. The second flat structure advantageously runs largely horizontally in this case.

Especially preferably, one front edge of the first flat structure and one front edge of the second flat structure are attached to the roller-blind axis and another front edge of the first flat structure is attached to a transverse web of the stretching bow and another front edge of the second flat structure is attached fixed in place to the motor vehicle. The front edges may be attached especially well and solidly to the roller-blind axis and the two struts. Furthermore, the material outlay for spanning the active area of the wind deflector may be kept low.

The motor vehicle according to the present invention preferably has a transparent area, in particular a glass area. The roller-blind device is also situated and implemented so that it at least partially covers the transparent area in its active position. The roller-blind device according to the present invention may therefore be used, for example, as a simply implemented and reliable light and sun protector for the motor vehicle.

Preferably, a roof of the motor vehicle has a transparent area. Such a roof offers a good and open travel feeling to a passenger seated in the motor vehicle, but subjects him or her to strong solar radiation in particular under certain circumstances. The passenger may be protected especially simply and well from this solar radiation by the configuration of the roller-blind device. For this purpose, the roller-blind device is advantageously situated below the roof.

The roller-blind axis is especially advantageously implemented on a roof spar of the roof. This implementation may be used both for the stability of the roof structure and also for rolling and unrolling the flat structure.

The roller-blind device is preferably situated and implemented such that the first flat structure is unrollable from the roller-blind axis in the direction of a windshield and the second flat structure is unrollable in the direction of a rear area of the motor vehicle. The roller-blind axis may particularly be situated in the middle of the roof in the longitudinal direction of the motor vehicle for this purpose. The flat structures may be implemented approximately equally large for this purpose. The active area spanned by the first flat structure thus covers a partial area of the roof in the direction of the windshield and the active area spanned by the second flat structure covers a partial area of the roof in the direction of the rear of the motor vehicle.

Especially advantageously, one front edge of the first flat structure and one front edge of the second flat structure are attached to the roller-blind axis and another front edge of the first flat structure is attached to a first, extendable strut and another front edge of the second flat structure is attached to a second, extendable strut. The front edges may be attached especially well and solidly to the roller-blind axis and the two struts. Furthermore, the material outlay for spanning the active area of the wind protector may be kept low.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic, perspective illustration of an embodiment of a wind deflector according to the present invention, having a roller-blind device whose roller-blind axis is situated on a roof arch, used in a cabriolet.

FIG. 2 is a schematic sectional illustration of the wind deflector shown in FIG. 1.

FIG. 3 is an embodiment of a motor vehicle having a roller-blind device according to the present invention situated below a glass area of a roof.

### DETAILED DESCRIPTION OF THE DRAWINGS

In the following, identical reference numerals are used for identifying identical or identically-acting elements, i.e., having the same functionality.

FIG. 1 shows a portion of a cabriolet 1 according to the present invention, which portion is situated between driver and passenger seats and a vehicle rear. A wind deflector 2 is situated in this part of the cabriolet 1. In the transverse direction of the cabriolet 1, the wind deflector 2 is constructed essentially mirror-symmetric to an axis running through the vehicle's middle in its longitudinal direction. Therefore, for reasons of clarity, only the left, lateral part of the cabriolet 1 and a left part of the wind deflector 2 are shown in FIG. 1.

The wind deflector 2 contains a stretching bow 3 that contains two diametrically opposite, spaced lateral spars connected to one another by a transverse web 4, preferably as a one piece unit. FIG. 1 shows the left lateral spar 5 of the stretching bow 3. The stretching bow 3 is mounted fixed in place and pivotably in diametrically opposite, lateral areas of a vehicle body 6 of the cabriolet 1. The stretching bow 3 is thus mounted so it is pivotable on the vehicle body 6 around a fixed pivot axis 7 (dashed lines) extending in the vehicle's transverse direction. The pivot axis 7 runs parallel to the transverse web 4 of the stretching bow 3.

The wind deflector 2 also contains a roof arch 8, implemented as bow-shaped here and containing two diametrically opposite spaced lateral spars that are connected to one another by a transverse web 9, preferably also as a one piece unit. FIG. 1 shows a left lateral spar 10 of the roof arch 8. The roof arch 8 is mounted fixed in place and pivotably in diametrically opposite, lateral areas of the vehicle body 6 of the cabriolet 1. The roof arch 8 is thus mounted so it is pivotable on the vehicle body around a fixed pivot axis 11 (dashed lines) extending in the transverse direction. The pivot axis 11 runs parallel to the transverse web 9 of the roof arch 8. The pivot axis 7 of the stretching bow 3 and the pivot axis 11 of the roof arch 8 are spaced from one another in the longitudinal direction of the cabriolet 1. In the illustrated embodiment, the pivot axis 11 is implemented behind the pivot axis 7 as viewed in the forward travel direction of the cabriolet 1.

The wind deflector 2 may assume a neutral position in which it is laid down to the rear in the longitudinal direction of the cabriolet 1 and does not span an active area for protection from wind. The stretching bow 3 and the roof arch 8 are pivoted downward and lie essentially at the height of an equator of the cabriolet 1. The stretching bow 3 lies on the roof arch 8. In its active position, the wind deflector 2 spans an active area for protecting a passenger area of the cabriolet 1 from wind. In the active position, the stretching bow 3 is pivoted upward by approximately 90° starting from the laid-down neutral position, so that its lateral spars extend nearly vertically upward. The roof arch 8 is pivoted forward approximately 180° starting from the neutral position, so that it lies essentially at the height of the equator of the cabriolet 1, its lateral spars running nearly horizontally and the transverse web 9 lying in front of the pivot axis 11 in the forward travel direction.

The stretching bow 3 and the roof arch 8 may be connected to drives, for pivoting them around their respective pivot axis 7 or 11. Stretching bow 3 and roof arch 8 may also be connected to one another using a coupling mechanism, however, so that only one of the two, or the coupling mechanism, has to be driven and this drive movement is transmitted to the particular other component. For example, the drive may be a motorized drive having an electric motor or a hydraulic drive.

For spanning active areas which ensure protection in its active position, the wind deflector 2 has a roller-blind device 12 rotatably mounted on a roller-blind axis 13 that is implemented on the transverse web 9 of the roof arch 8. A front edge 14 of a first net tarpaulin 15 and a front edge 16 of a second net tarpaulin 17 are attached to the roller-blind axis 13. Another front edge 18 of the net tarpaulin 15 is attached to the transverse web 4 of the stretching bow 3 and another front edge 19 of the net tarpaulin 17 is attached to a strut 20 of the vehicle body 6 in the rear area of the cabriolet 1. The first net tarpaulin 15 and the second net tarpaulin 17 of the roller-blind device 12 are flexible flat structures made of net-like materials implemented in a planar configuration here. The two net tarpaulins 15, 17 may be rolled onto and unrolled from the rotatable roller-blind axis 13 using this axis. In the neutral position of the wind deflector 2, which corresponds to a neutral position of the roller-blind device 12, the two net tarpaulins 15, 17 are rolled lying one on top of another on the roller-blind axis 13 in their rolled-up state. The two net tarpaulins 15, 17 are rolled onto the roller-blind axis 13 in a spiral.

Upon adjustment of the wind deflector 2 from its neutral position into its active position, which corresponds to an active position of the roller-blind device 12, the roller-blind axis 13 rotates due to the pivoting of the stretching bow 3 and the roof arch 8. The net tarpaulins 15, 17 unroll in different directions from the roller-blind axis 13. The net tarpaulin 15 spans an active partial area 21 in its active position upon pivoting of the wind deflector 2. This is indicated in FIG. 1 by an arrow 22. The arrow 22 indicates the direction in which the net tarpaulin 15 is unrolled from the roller-blind axis 13. The net tarpaulin 17 simultaneously spans the active partial area 23. This is indicated in FIG. 1 by an arrow 24. The arrow 24 indicates the direction in which the net tarpaulin 17 is unrolled from the roller-blind axis 13.

In the completely active position of the wind deflector 2, the stretching bow 3 is pivoted essentially vertically upward and the roof arch 8 is pivoted by nearly 180° forward, so that it again lies horizontally at the height of the equator of the cabriolet 1. The transverse web 9 of the roof arch 8 lies approximately below the transverse web 4 of the stretching bow 3. The active partial area 21 ensures good wind protection and extends from the transverse web 4 up to the transverse web 9. The area 21 covers, as a function of possible inclination of the lateral spars of the stretching bow 3 inward and the width of the net tarpaulin 15 in the transverse direction, an area nearly completely spanned by the stretching bow 3. The active area 23 extends from the transverse web 9 located at the height of the equator of the cabriolet 1 up to the strut 20. The active area 23 ensures coverage of a space lying underneath it. This space is a rear seat space of the cabriolet 1 here. The active area 23 thus ensures protection of the space lying underneath it from harmful external influences.

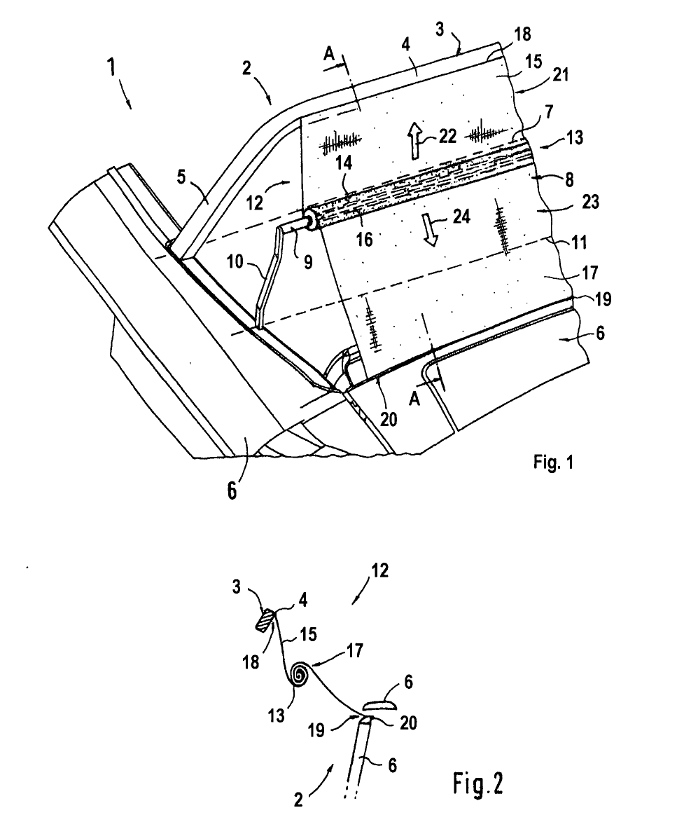

FIG. 2 is a schematic illustration of section A-A in FIG. 1. The double rolling of the two net tarpaulins 15, 17 lying one on top of another on the transverse web 9 of the roof arch 8 implemented as the roller-blind axis 13 may be seen. The front edge 18 of the net tarpaulin 15 is attached to the transverse web 4 of the stretching bow 3 and the front edge 19 of the net tarpaulin 17 is additionally attached to the strut 20. The two net tarpaulins 15, 17 are thus automatically unrolled from the roller-blind axis 13 upon pivoting of the wind deflector 2. The rolling procedure for rolling the unrolled net tarpaulins 15, 17 occurs in the reverse direction. The two net tarpaulins 15, 17 are again rolled onto the roller-blind axis 13 lying one on top of another.

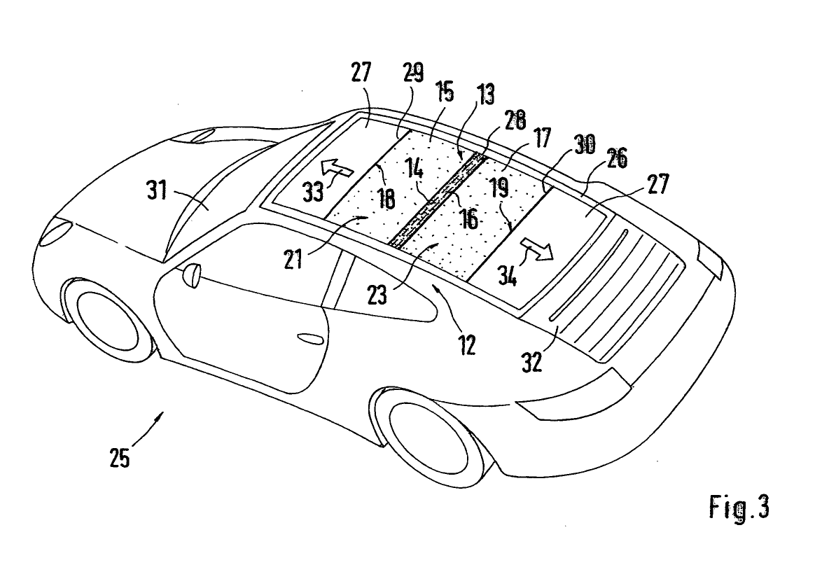

FIG. 3 shows a further embodiment of a motor vehicle according to the present invention. The motor vehicle is a closed motor vehicle 25 here having a transparent roof 26 that is a glass roof having a glass area 27. The roller-blind device 12 according to the present invention is situated below the glass area 27 and has the rotatable roller-blind axis 13 that is implemented here on a roof spar 28 of the motor vehicle 25 running in the transverse direction. The roof spar 28 is situated fixed in place on the vehicle body 6 of the motor vehicle 25. The front edges 14, 16 of the two net tarpaulins 15, 17, respectively, are attached to the roller-blind axis 13. The other front edge 18 of the net tarpaulin 15 is attached to a strut 29 and the other front edge 19 of the net tarpaulin 17 is attached to a strut 30.

The struts 29, 30 run in the transverse direction of the motor vehicle 25 and are situated below the roof 26 so they are displaceable in the longitudinal direction of the motor vehicle 25. The strut 29 is situated in front of the roof spar 28 and the strut 30 is situated behind it, viewed in the forward travel direction. The strut 29 is essentially movable between the roof spar 28 and a forward end of the glass area 27, viewed in the forward travel direction. The forward end of the glass area 27 neighbors a windshield 31 of the motor vehicle 25. The strut 30 is essentially movable between the roof spar 28 and a rear end of the glass area 27, viewed in the forward travel direction. The rear end of the glass area 27 neighbors a rear area 32 of the motor vehicle 25.

In the neutral position of the roller-blind 12, the two struts 29, 30 press against the roof spar 28 having the roller-blind axis 13. The glass area 27 is open to the passenger space and is not covered by the roller-blind device 12. To span the active partial area 21 using the net tarpaulin 15, the strut 29, starting from the neutral position of the roller-blind device 12, is moved in the direction of the windshield 31. This is indicated in FIG. 3 by an arrow 33. To span the active partial area 23 using the net tarpaulin 17, the strut 30, starting from the neutral position of the roller-blind device 12, is moved in the direction of the rear area 32. This is indicated in FIG. 3 by an arrow 34. In this embodiment, the direction indicated by the arrow 33 and the direction indicated by the arrow 34 are essentially opposite to one another. In the active position of the roller-blind device 12, the two active partial areas 21, 23 are completely spanned and approximately cover the entire partial area 27. The two net tarpaulins 15, 17 thus have a size which is tailored to the size of the glass area 27.

The width of the net tarpaulins 15, 17 in the transverse direction approximately corresponds to the width of the glass area 27 and the length of the net tarpaulins 15, 17 in the longitudinal direction approximately corresponds to half of the length of the glass area 27. For this purpose, the roller-blind axis 13 is situated in the middle of the glass area 27 viewed in the longitudinal direction. An intermediate position of the roller-blind device 12 between its neutral position and its active position is shown in FIG. 3. The two net tarpaulins 15, 17 are partially unrolled from the roller-blind axis 13 and cover a part of the glass area 27. The two net tarpaulins 15, 17 are rolled onto the roller-blind axis 13 lying one on top of another in the neutral position. To move the roller-blind device 12 into its active position, both net tarpaulins 15, 17 are simultaneously unrolled from the roller-blind axis 13. For this purpose, a drive engages on the struts 29, 30 and moves them in the direction of the windshield 31 and the rear area 32, respectively.

To move the roller-blind device 12 from its active position into its neutral position, the two struts 29, 30 are moved in the direction of the roof spar 28. The two net tarpaulins 15, 17 are rolled onto the roller-blind axis 13 lying one on top of another. The net tarpaulins 15, 17 may advantageously be unrolled and rolled continuously from and onto the roller-blind axis 13. Thus, any arbitrary intermediate position between the neutral position and the active position of the roller-blind device 12 is settable to cover at least a part of the glass area 27.

In the embodiment of FIG. 3, the roller-blind axis 13 is implemented fixed in place on the roof spar 28. However, it is also contemplated to situate one of the struts 29 or 30 fixed in place on the motor vehicle 25 and to implement the other of the struts 30 or 29, respectively, and the roller-blind axis 13 as movable below the roof 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A roller-blind device for a motor vehicle comprises a first flexible flat structure and a second flexible flat structure operatively arranged at a rotatable roller-blind axis and arranged to be rollable onto the roller-blind axis and unrollable from the roller-blind axis in different directions.

2. The roller-blind device according to claim 1, wherein the first flexible flat structure and the second flexible flat structure are rollable onto the roller-blind axis lying one on top of another in a neutral position of the roller-blind device.

3. The roller-blind device according to claim 1, wherein one front edge of the first flexible flat structure and one front edge of the second flexible flat structure are operatively attached to the roller-blind axis and another front edge of the first flexible flat structure is operatively attached to a first strut and another front edge of the second flexible flat structure is operatively attached to a second strut.

4. The roller-blind device according to claim 3, wherein at least one of the first strut and the second strut is movable to unroll and roll the at least one of first flexible flat structure and the second flexible flat structure from and onto the roller-blind axis.

5. The roller-blind device according to claim 3, wherein the first strut or the second strut is mounted fixed in place, and the roller-blind axis is movable to unroll and roll at least one of the first flexible flat structure and the second flexible flat structure from and onto the roller-blind axis.

6. The roller-blind device according to claim 1 wherein the first flexible flat structure and the second flexible flat structure have a net-like material.

7. A wind deflector for motor vehicle having a roller-blind device according to claim 1.

8. The wind deflector according to claim 7, further comprising a stretching bow operatively mounted to be pivotable around a first pivot axis oriented in a transverse direction of the motor vehicle and fixed in place, and a roof arch operatively mounted to be pivotable around a second pivot axis extending in the transverse direction of the motor vehicle and fixed in place, the second pivot axis being spaced from the pivot axis as viewed in a longitudinal direction of the motor vehicle wherein the roller-blind axis is operatively associated at the roof arch parallel to the second pivot axis.

9. The wind deflector according to claim 8, wherein the roller-blind axis is implemented on a transverse web of the roof arch extending parallel to the second pivot axis.

10. The wind deflector according to claim 9, wherein the first flexible flat structure is operatively fastened to the stretching bow, and the second flexible flat structure is operatively fastened and fixed in place to a rear area of the motor vehicle.

11. The wind deflector according to claim 10, wherein a front edge of the first flexible flat structure and a front edge of the second flexible flat structure are operatively attached to the roller-blind axis and another front edge of the first flexible flat structure is operatively attached to a transverse web of the stretching bow and another front edge of the second flexible flat structure is operatively attached fixed in place to the motor vehicle.

12. A motor vehicle having a roller-blind device according to claim 1.

13. The motor vehicle according to claim 12, wherein the motor vehicle has a transparent area, and the roller-blind device is configured and arranged so that it at least partially covers a transparent area in an active position of the roller blind device.

14. The motor vehicle according to claim 13, wherein the transparent area has a glass area.

15. The motor vehicle according to claim 13, wherein a roof of the motor vehicle includes the transparent area.

16. The motor vehicle according to claim 15, wherein the roller-blind axis is implemented on a roof spar of the roof.

17. The motor vehicle according to claim 12, wherein the roller-blind device is configured and arranged so as that the first flexible flat structure is unrollable from the roller-blind axis in a direction of a windshield and the second flexible flat structure is unrollable in a direction of a rear area of the motor vehicle.

18. The motor vehicle according to claim 17, wherein one front edge of the first flexible flat structure and one front edge of the second flexible flat structure are attached to the roller-blind axis and another front edge of the first flexible flat structure is attached to a first, movable strut and another front edge of the second flexible flat structure is attached to a second, movable strut.
